(19) United States
(12) Patent Application Publication
(10) Pub. No.: US 2005/0284314 A1
(43) Pub. Date: Dec. 29, 2005

(54) Screen printing image enhancement

(76) Inventors: Joseph M. Coulter, Whitehall, OH (US); Jeffrey W. McConnaughey, Columbus, OH (US); David W. Bowman, Grove City, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/071,666

(22) Filed: Mar. 3, 2005

Related U.S. Application Data
(60) Provisional application No. 60/583,430, filed on Jun. 28, 2004.

(51) Int. Cl. B41M 1/12

(52) U.S. Cl. 101/129

(57) ABSTRACT

A method of screen printing an image or design onto a substrate comprising: (a) depositing a plurality of inks over a temporary substrate, the plurality of inks comprising an image or design; (b) depositing a backing material over the image or design; and (c) depositing a white colored ink over the backing material so that the backing material comprises an intervening layer between at least a portion of the white colored ink and the image or design.

### CROSS REFERENCE TO RELATED APPLICATIONS

This application claims the benefit of U.S. Provisional Patent Application Ser. No. 60/583,430, filed Jun. 28, 2004, and entitled “SCREEN PRINTING IMAGE ENHANCEMENT,” the disclosure of which is incorporated herein by reference.

### BACKGROUND

1. Field of the Invention

The present invention is directed to image printing and, more specifically, to methods of screen printing and goods incorporating images printed using such methods.

2. Background of the Invention

A conventional screen printing apparatus for printing multiple-colored images on a temporary substrate is normally comprised of a number of separate screen frames or printing heads each adapted to print an image of a different color. Oftentimes, the temporary substrate is advanced in step-by-step fashion so that predefined areas of the temporary substrate receive ink from each of the screens until the desired composites multi-colored image is produced. A registration system electrically interconnected with the temporary substrate advancement drive is provided to cause predefined areas of the temporary substrate to be brought into a desired, predetermined positional alignment with each of the printing screens as the temporary substrate areas are advanced from one screen to the next.

As can be appreciated, it is normally important to insure that the inked image printed by one of the screen printing heads is dried or cured before a second colored image is printed over the first image. Otherwise, interaction between the two differently colored inks may cause the colors to run or bleed, and the sharpness of outline or contour of the composite image will be somewhat diminished. Furthermore, if a portion of ink remains wet on the temporary substrate, it may adhere to the screen of the next downstream printing unit, thereby causing further interaction of the inks as well as other problems. In recent years, increased interest has been directed toward inks that are cured by a source of radiation such as ultraviolet, infrared or electron beam.

Regardless of the techniques utilized to screen print an image, it has been a goal of the screen printing industry to achieve screen prints having picture quality with vibrant and well defined color boundaries. In addition, it has been a goal of the screen printing industry to achieve screen prints on darker colored permanent substrates that match the visual quality of images printed on lighter colored permanent substrates, particularly white substrates.

### SUMMARY

The present invention is directed to image printing and, more specifically, to enhancing the visual appeal of a screen printed image to simulate the appearance of photograph duplicate quality. The present invention is applicable to screen printing images that will be coupled to a darker colored permanent substrate, and may also be utilized with lighter colored permanent substrates.

The present invention includes a novel step of printing a white ink onto the backside of a backing material so that the white ink interposes the backing material and the permanent substrate when the transfer is coupled to the permanent substrate. As used herein, permanent substrate refers to the final medium onto which the printed image is permanently adhered to and includes, without limitation, T-shirts, ball caps, pants, and other articles of clothing, as well as items for display. The use of the white ink interposing the backing material and permanent substrate results in images having a brighter, distinct visual effect that more closely simulates the visual effect of a photograph and presents a considerable improvement over prior art techniques in screen printing.

It is a first aspect of the present invention to provide a method of screen printing an image or design onto a temporary substrate comprising: (a) depositing a plurality of inks over a temporary substrate, the plurality of inks comprising an image or design; (b) depositing a backing material over the image or design; and (c) depositing a white colored ink over the backing material so that the backing material comprises an intervening layer between at least a portion of the white colored ink and the image or design.

In a more detailed embodiment of the first aspect, the act of depositing the plurality of inks includes sequentially depositing a plurality of colored inks onto the temporary substrate to comprise the image or design, the act of depositing the backing material includes depositing the backing material to at least partially overlie the image or design, and the act of depositing the white colored ink includes depositing the white colored ink to at least partially overlie the backing material overlying the image or design. In yet another more detailed embodiment, the invention further includes drying at least one of the plurality of inks deposited onto the temporary substrate subsequent to deposition of each of the plurality of inks, drying the backing material subsequent to deposition of the backing material, and drying the white colored ink subsequent to deposition of the white colored ink. In a further detailed embodiment, the backing material includes a first side at least substantially contacted by the white colored ink deposited, and the backing material includes a second side at least substantially contacted by at least one of the plurality of inks, where the plurality of inks include at least one of a clear colored ink, a black colored ink, a magenta colored ink, a cyan colored ink, and a yellow colored ink. In still a further detailed embodiment, the backing material is deposited and in intimate contact with at least one of the plurality of inks, and the white colored ink is deposited and in intimate contact with at least a portion of the backing material.

It is a second aspect of the present invention to provide a method of screen printing an image or design onto a permanent substrate comprising: (a) depositing a plurality of inks over a temporary substrate, the plurality of inks comprising an image or design; (b) depositing a backing material over the image or design; (c) depositing a white colored ink over the backing material so that the backing material comprises an intervening layer between at least a portion of the white colored ink and the image or design; (d) orienting the temporary substrate with respect to a permanent substrate so that the image or design at least partially interposes the temporary substrate and the permanent substrate; and (e) heating at least one of the temporary substrate, the image or design, and the permanent substrate to couple the image or design to the permanent substrate.

In a more detailed embodiment of the second aspect, the act of depositing the plurality of inks includes sequentially depositing a plurality of colored inks onto the temporary substrate to comprise the image or design, the act of depositing the backing material includes depositing the backing material to at least partially overlie the image or design, and the act of depositing the white colored ink includes depositing the white colored ink to at least partially overlie the backing material overlying the image or design. In yet another more detailed embodiment, the invention further includes drying at least one of the plurality of inks deposited onto the temporary substrate subsequent to deposition of each of the plurality of inks, drying the backing material subsequent to deposition of the backing material, and drying the white colored ink subsequent to deposition of the white colored ink. In a further detailed embodiment, the backing material includes a first side at least substantially contacted by the white colored ink deposited, and the backing material includes a second side at least substantially contacted by at least one of the plurality of inks, where the plurality of inks include at least one of a clear colored ink, a black colored ink, a magenta colored ink, a cyan colored ink, and a yellow colored ink.

In yet another more detailed embodiment of the second aspect, the backing material is deposited in intimate contact with at least one of the plurality of inks, the white colored ink is deposited in intimate contact with at least a portion of the backing material, and the act of heating at least one of the temporary substrate, the image or design, and the permanent substrate and bringing the white colored ink into intimate contact with the permanent substrate is operative to couple the image or design to the permanent substrate.

It is a third aspect of the present invention to provide a method of screen printing an image or design onto a temporary substrate comprising: (a) depositing a first ink on a temporary substrate; (b) drying the first ink on the temporary substrate; (c) depositing a second ink on the temporary substrate; (d) drying the second ink on the temporary substrate; (e) depositing a backing material ink over the first ink and the second ink; (f) drying the backing material ink; (g) depositing a white colored ink over the backing material ink that overlies the first ink and the second ink; and (h) drying the white colored ink over the backing material ink.

In a more detailed embodiment of the third aspect, the present invention further includes: (a) depositing a third ink on a temporary substrate; (b) drying the third ink on the temporary substrate; (c) depositing a fourth ink on the temporary substrate; (d) drying the fourth ink on the temporary substrate; (e) depositing a fifth ink on a temporary substrate; (f) drying the fifth ink on the temporary substrate; (g) depositing a sixth ink on the temporary substrate; and, (h) drying the sixth ink on the temporary substrate. In yet another more detailed embodiment, the act of depositing the first ink over the temporary substrate includes depositing a clear ink over the temporary substrate, the act of depositing the second ink over the temporary substrate includes depositing a black colored ink over the temporary substrate, the act of depositing the third ink over the temporary substrate includes depositing a magenta colored ink over the temporary substrate, the act of depositing the fourth ink over the temporary substrate includes depositing a cyan colored ink over the temporary substrate, the act of depositing the fifth ink over the temporary substrate includes depositing a yellow colored ink ink over the temporary substrate, the act of depositing the sixth ink over the temporary substrate includes depositing a white colored ink ink over the temporary substrate, and the act of depositing the backing material occurs subsequent to the act of depositing the plurality of inks over the temporary substrate.

It is a fourth aspect of the present invention to provide a method of screen printing an image or design onto a permanent substrate comprising: (a) depositing a first ink on a temporary substrate; (b) drying the first ink on the temporary substrate; (c) depositing a second ink on the temporary substrate; (d) drying the second ink on the temporary substrate; (e) depositing a backing material ink over the first ink and the second ink; (f) drying the backing material ink; (g) depositing a white colored ink over the backing material ink that overlies the first ink and the second ink; (h) drying the white colored ink over the backing material ink; (i) orienting the temporary substrate with respect to a permanent substrate so that at least one of the first ink, the second ink, the backing material ink, and the white colored ink interpose the temporary substrate and the permanent substrate; and (j) heating at least one of the temporary substrate, the image or design, the backing material ink, the white colored ink, and the permanent substrate to bond the image or design to the permanent substrate.

In a more detailed embodiment of the fourth aspect, the act of heating at least one of the temporary substrate, the image or design, the backing material ink, the white colored ink, and the permanent substrate includes concurrently applying pressure to at least one of the temporary substrate, the image or design, the backing material ink, the white colored ink, and the permanent substrate. In yet another more detailed embodiment, the act of depositing the white colored ink includes depositing the white color ink directly on the backing material ink.

It is a fifth aspect of the present invention to provide a tangible article comprising a permanent substrate associated with an article of clothing that includes a screen printed image fabricated from a sequential deposition process that included depositing an ink followed by deposition of a backing material, followed by deposition of a white colored ink so that after the screen printed image is mounted to the permanent substrate, the white colored ink interposes the backing material and the permanent substrate.

In a more detailed embodiment of the first aspect, the screen printed image is a pictorial representation fabricated by sequentially depositing a plurality of inks prior to deposition of the backing material. In yet another more detailed embodiment, the article of clothing includes at least one of a shirt, a coat, and a hat. In a further detailed embodiment, the screen printed image includes the white colored ink adjacent to the backing material.

It is a sixth aspect of the present invention to provide a tangible article comprising a permanent fabric substrate associated with an article of clothing that includes a screen printed image fabricated from a sequential deposition process that included depositing an ink followed by deposition of a backing material, followed by deposition of a white colored ink so that after the screen printed image is mounted to the permanent substrate, the white colored ink interposes the backing material and the permanent substrate.

### BRIEF DESCRIPTION OF THE DRAWINGS

FIG. 1 is an exemplary process flow diagram for a first exemplary embodiment in accordance with the present invention; and

FIG. 2 is an exemplary process flow diagram for a second exemplary embodiment in accordance with the present invention.

### DETAILED DESCRIPTION

The exemplary embodiments of the present invention are described and illustrated below to encompass methods of printing images onto a temporary substrate as well as goods that include the eventual printed images. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

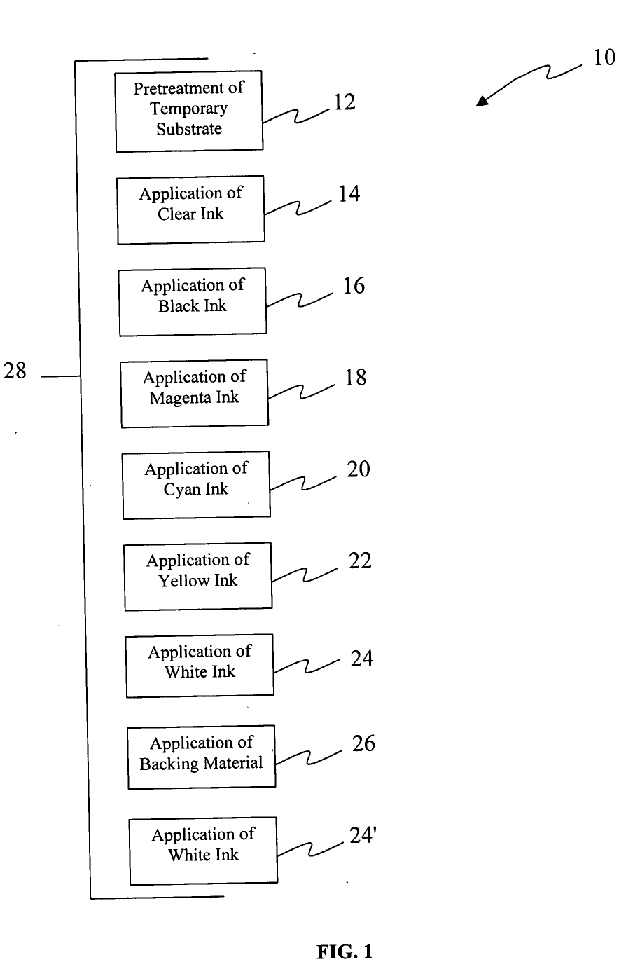

Referencing FIG. 1, a first exemplary screen printing process 10 includes printing selected inks in sequence that cooperate to provide a colored visual representation. The first exemplary screen printing process 10 may utilize a temporary substrate 12 such as paper or another consumable substrate. Exemplary paper for use in the present invention as a temporary substrate includes Fox River and Tullis Russell paper. The temporary substrate 12 may be processed prior to the application of inks to minimize variations in size resulting from environment conditions attributable to the screen printing process 10. An exemplary preparatory process for a paper temporary substrate 12 may include preshrinking the paper 12.

The first exemplary screen printing process 10 includes printing a clear colored ink 14, using a 160 mesh with a 70 durometer squeegee having a 10 degree angle, onto the preshrunk paper substrate 12. The clear colored ink 14 is dried using conventional techniques know to those of ordinary skill that include, without limitation, heat treatment. For instance, the paper substrate and newly deposited ink may be positioned within a 240° F. ambient dryer for a period of 30 seconds to dry or cure the deposited ink. As used herein, the term dried or the process or drying refers to diminishing the fluid content of the ink to a such a degree that commingling between different deposited inks is inhibited. Thereafter, a series of colored inks 16, 18, 20, 22 are sequentially applied over the clear colored ink 14.

An exemplary sequence for printing the series of colored inks 16, 18, 20, 22 includes first printing black colored ink 16 subsequent to the printing of the clear colored ink 14. The blank colored ink 16 is applied using a 355 mesh with a 70 durometer squeegee having a 15 degree angle. The black colored ink 16 is dried subsequent to deposition using conventional techniques know to those of ordinary skill. An exemplary drying technique includes exposing the recently deposited ink to a 240° F. ambient dryer for a period of 30 seconds. Thereafter, a magenta colored ink 18 is printed onto the paper substrate 12 using a 355 mesh with a 70 durometer squeegee having a 15 degree angle, and subsequently dried in a 240° F. ambient dryer for a period of 30 seconds. A cyan colored ink 20 is printed subsequent to the magenta colored ink 18 using a 355 mesh with a 70 durometer squeegee having a 15 degree angle. The cyan colored ink 20 is dried for 30 seconds in a 240° F. ambient dryer prior to the deposition of a yellow colored ink 22. The yellow colored ink 22 is deposited onto the paper substrate 12 using a 355 mesh with a 70 durometer squeegee having a 15 degree angle, and thereafter dried in an 240° F. ambient dryer for 30 seconds.

A white colored ink 24 is printed over the series of colored inks 16, 18, 20, 22 to provide white highlights to the printed image. The white colored ink 24 is applied using a 160 mesh with a 70 durometer squeegee having a 15 degree angle. An 888 series stretchable backing 26 available from Lancer Group International (www.lancergroup.com) is applied to the substrate 12 after the white colored ink 24 is deposited and dried via exposure to a 240° F. ambient dryer for a period of 30 seconds. The backing 26 is applied using a 109 mesh with a 90 durometer squeegee having a 10 degree angle. A white colored ink 24′ using a 109 mesh with a 90 durometer squeegee having a 10 degree angle is deposited following drying of the backing 26 in the 240° F. ambient dryer. It is to be understood that the white colored ink 24′ may be the same white colored ink 24 deposited prior to the backing 26, or a different white colored ink.

The paper substrate 12 along with the printed inks 14, 16, 18, 20, 22, 24 and backing 26 comprises a transfer 28 that may be thereafter applied to a permanent substrate (not shown). Exemplary permanent substrates include, without limitation, T-shirts, ball caps, pants, and other wearable or displayable articles.

An exemplary process for mounting the transfer 28 to the permanent substrate includes utilization of a Hix HT-400 heat press. The transfer 28 is oriented for bonding to the permanent substrate so that the paper substrate 12 faces away from the permanent substrate and the white colored ink 24 applied to the backing 26 is in intimate contact with the permanent substrate. Exemplary process conditions include, without limitation, closing the heat press in order to apply a medium heavy pressure operative to push the transfer 28 into contact with the permanent substrate for a duration of approximately six seconds and at an operating temperature of 400 degrees Fahrenheit. Thereafter, the heat press is opened and the paper substrate 12 is removed to reveal the visual representation affixed to the permanent substrate.

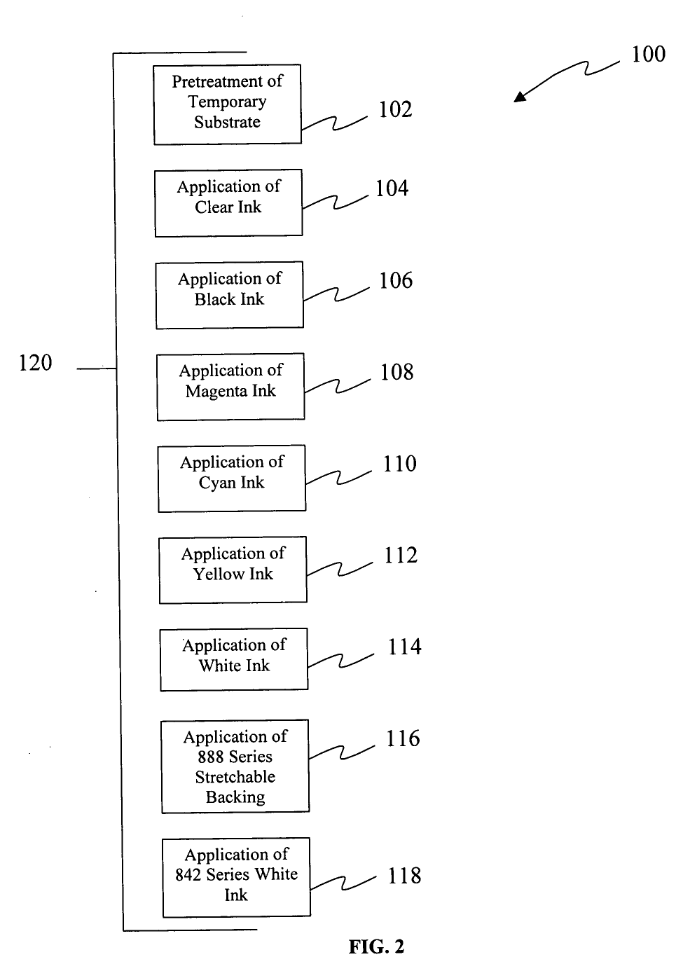

Referencing FIG. 2, a second exemplary screen printing process 100 includes printing selected inks in sequence that cooperate to provide a colored visual representation. The second exemplary screen printing process 100 utilizes a temporary substrate 102 processed prior to application of ink to minimize size variations throughout the screen printing process 100.

The second exemplary screen printing process 100 includes printing a clear colored ink 104, using a 160 mesh with a 70 durometer squeegee having a 10 degree angle, onto a temporary substrate 102. The clear colored ink 104 is dried using conventional techniques know to those of ordinary skill that include, without limitation, heat treatment. This second exemplary embodiment utilizes a 240° F. ambient dryer to dry the inks a period of 30 seconds, and thereafter a subsequent may be applied. In this instance, a series of colored inks 106, 108, 110, 112 are sequentially applied over the clear colored ink 104.

An exemplary sequence for printing the series of colored inks 106, 108, 110, 112 includes printing black colored ink 106 subsequent to the printing of the clear colored ink 104. The blank colored ink is applied using a 355 mesh with a 70 durometer squeegee having a 15 degree angle, and thereafter dried. A magenta colored ink 108 is printed onto the temporary substrate 102, subsequent to drying of the black colored ink, using a 355 mesh with a 70 durometer squeegee having a 15 degree angle. The magenta colored ink 108 is dried and followed by the printing of a cyan colored ink 110 using a 355 mesh with a 70 durometer squeegee having a 15 degree angle. The cyan colored ink 110 is dried prior to the deposition of a yellow colored ink 112. The yellow colored ink 112 is deposited onto the temporary substrate 102 using a 355 mesh with a 70 durometer squeegee having a 15 degree angle, and thereafter dried.

A white colored ink 114 is printed over the series of colored inks 106, 108, 110, 112 to provide white highlights to the eventual colored visual representation. The white colored ink 114 is applied using a 160 mesh with a 70 durometer squeegee having a 15 degree angle. An 888 series stretchable backing 116 available from Lancer Group International (www.lancergroup.com) is applied over the temporary substrate 102 after the white colored ink 114 is deposited and dried. The stretchable backing 116 is applied using a 109 mesh with a 90 durometer squeegee having a 10 degree angle. An 842 series white colored ink 118 available from Lancer Group International (www.lancergroup.com) is applied over the temporary substrate 102 using a 109 mesh with a 90 durometer squeegee having a 10 degree angle after the application and drying of the 888 series stretchable backing 116. A completed transfer 120 is formed subsequent to drying of the 842 series white colored ink 118 and is ready to be applied to a permanent substrate (not shown).

An exemplary process for mounting the transfer 120 to the permanent substrate includes utilization of a Hix HT-400 heat press. The transfer 120 is oriented for bonding to the permanent substrate so that the temporary substrate 102 faces away from the permanent substrate and the 842 series white colored ink 118 applied to the 888 series stretchable backing 116 is in intimate contact with the permanent substrate. Exemplary process conditions include, without limitation, closing the heat press in order to apply a medium heavy pressure operative to push the transfer 120 into contact with the permanent substrate for a duration of approximately six seconds and at an operating temperature of 400 degrees Fahrenheit. Thereafter, the heat press is opened and the temporary substrate 102 is removed to reveal a visual representation affixed to the permanent substrate 122.

It is also within the scope and spirit of the present invention to provide an intermediary layer of clear colored ink between the backing 26, 116 and the white colored ink 24′, 118.

Exemplary inks for use with the present invention are available from Lancer Group International (www.lancergroup.com) and include the Excalibur Plastisol Inks PF Series conforming to the requirements of the European Union prohibiting the placing in the market of toys and childcare articles intended to be placed in the mouth of children under three years of age that are made from polyvinyl chloride containing phthalates. It is to be understood, however, that other inks may be utilized in addition to or in lieu of the exemplary inks recited in the first and second exemplary embodiments 10, 100. For example, the present invention may utilize inks that are not discernable by the naked human eye, but require artificial viewing devices such as infrared vision or 3-D glasses. It is also within the scope of the invention that fluorescent and phosphorescent inks be utilized to print the colored visual representation.

Exemplary permanent substrates for use with the present invention include, without limitation, hats, jackets, pants, shirts, and other clothing. It is to be understood that the present invention is not limited to substrates that are donned and may also include any substrate upon which the visual representation is permanently mounted.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

1. A method of screen printing an image or design onto a temporary substrate comprising:
depositing a plurality of inks over a temporary substrate, the plurality of inks comprising an image or design;
depositing a backing material over the image or design; and
depositing a white colored ink over the backing material so that the backing material comprises an intervening layer between at least a portion of the white colored ink and the image or design.

2. A transfer fabricated in accordance with the method of claim 1.

3. The method of claim 1, wherein:
the act of depositing the plurality of inks includes sequentially depositing a plurality of colored inks onto the temporary substrate to comprise the image or design;
the act of depositing the backing material includes depositing the backing material to at least partially overlie the image or design; and
the act of depositing the white colored ink includes depositing the white colored ink to at least partially overlie the backing material overlying the image or design.

4. The method of claim 1, further comprising:
drying at least one of the plurality of inks deposited onto the temporary substrate subsequent to deposition of each of the plurality of inks;
drying the backing material subsequent to deposition of the backing material; and
drying the white colored ink subsequent to deposition of the white colored ink.

5. The method of claim 1, wherein the backing material includes an 888 Stretch Back Adhesive.

6. The method of claim 1, wherein the backing material includes a first side at least substantially contacted by the white colored ink deposited, and the backing material includes a second side at least substantially contacted by at least one of the plurality of inks, where the plurality of inks include at least one of a clear colored ink, a black colored ink, a magenta colored ink, a cyan colored ink, and a yellow colored ink.

7. The method of claim 1, wherein:
the backing material is deposited and in intimate contact with at least one of the plurality of inks; and
the white colored ink is deposited and in intimate contact with at least a portion of the backing material.

8. The method of claim 1, wherein:
the act of depositing a plurality of inks over a temporary substrate includes:
depositing a clear ink over the temporary substrate,
depositing a black colored ink over the temporary substrate,
depositing a magenta colored ink over the temporary substrate,
depositing a cyan colored ink over the temporary substrate, and
depositing a white colored ink over the temporary substrate; and
the act of depositing the backing material occurs subsequent to the act of depositing the plurality of inks over the temporary substrate.

9. A method of screen printing an image or design onto a permanent substrate comprising:
depositing a plurality of inks over a temporary substrate, the plurality of inks comprising an image or design;
depositing a backing material over the image or design;
depositing a white colored ink over the backing material so that the backing material comprises an intervening layer between at least a portion of the white colored ink and the image or design;
orienting the temporary substrate with respect to a permanent substrate so that the image or design at least partially interposes the temporary substrate and the permanent substrate; and
heating at least one of the temporary substrate, the image or design, and the permanent substrate to couple the image or design to the permanent substrate.

10. A permanent article fabricated in accordance with the method of claim 9.

11. The method of claim 9, wherein:
the act of depositing the plurality of inks includes sequentially depositing a plurality of colored inks onto the temporary substrate to comprise the image or design;
the act of depositing the backing material includes depositing the backing material to at least partially overlie the image or design; and
the act of depositing the white colored ink includes depositing the white colored ink to at least partially overlie the backing material overlying the image or design.

12. The method of claim 9, further comprising:
drying at least one of the plurality of inks deposited onto the temporary substrate subsequent to deposition of each of the plurality of inks;
drying the backing material subsequent to deposition of the backing material; and
drying the white colored ink subsequent to deposition of the white colored ink.

13. The method of claim 9, wherein the backing material includes an 888 Stretch Back Adhesive.

14. The method of claim 9, wherein the backing material includes a first side at least substantially contacted by the white colored ink deposited, and the backing material includes a second side at least substantially contacted by at least one of the plurality of inks, where the plurality of inks include at least one of a clear colored ink, a black colored ink, a magenta colored ink, a cyan colored ink, and a yellow colored ink.

15. The method of claim 9, wherein:
the backing material is deposited in intimate contact with at least one of the plurality of inks;
the white colored ink is deposited in intimate contact with at least a portion of the backing material; and
the act of heating at least one of the temporary substrate, the image or design, and the permanent substrate and bringing the white colored ink into intimate contact with the permanent substrate is operative to couple the image or design to the permanent substrate.

16. The method of claim 9, wherein:
the act of depositing a plurality of inks over a temporary substrate includes:
depositing a clear ink over the temporary substrate,
depositing a black colored ink over the temporary substrate,
depositing a magenta colored ink over the temporary substrate,
depositing a cyan colored ink over the temporary substrate,
depositing a yellow colored ink over the temporary substrate, and
depositing a white colored ink over the temporary substrate; and
the act of depositing the backing material occurs subsequent to the act of depositing the plurality of inks over the temporary substrate.

17. A method of screen printing an image or design onto a temporary substrate comprising:
depositing a first ink on a temporary substrate;
drying the first ink on the temporary substrate;
depositing a second ink on the temporary substrate;
drying the second ink on the temporary substrate;
depositing a backing material ink over the first ink and the second ink;
drying the backing material ink;
depositing a white colored ink over the backing material ink that overlies the first ink and the second ink; and
drying the white colored ink over the backing material ink.

18. A transfer fabricated in accordance with the method of claim 17.

19. The method of claim 17, further comprising:
depositing a third ink on a temporary substrate;
drying the third ink on the temporary substrate;
depositing a fourth ink on the temporary substrate;
drying the fourth ink on the temporary substrate;
depositing a fifth ink on a temporary substrate;
drying the fifth ink on the temporary substrate;
depositing a sixth ink on the temporary substrate; and
drying the sixth ink on the temporary substrate.

20. The method of claim 19, wherein:
the act of depositing the first ink over the temporary substrate includes depositing a clear ink over the temporary substrate;
the act of depositing the second ink over the temporary substrate includes depositing a black colored ink over the temporary substrate;
the act of depositing the third ink over the temporary substrate includes depositing a magenta colored ink over the temporary substrate;
the act of depositing the fourth ink over the temporary substrate includes depositing a cyan colored ink over the temporary substrate;
the act of depositing the fifth ink over the temporary substrate includes depositing a yellow colored ink ink over the temporary substrate;
the act of depositing the sixth ink over the temporary substrate includes depositing a white colored ink ink over the temporary substrate; and
the act of depositing the backing material occurs subsequent to the act of depositing the plurality of inks over the temporary substrate.

21. A method of screen printing an image or design onto a permanent substrate comprising:
depositing a first ink on a temporary substrate;
drying the first ink on the temporary substrate;
depositing a second ink on the temporary substrate;
drying the second ink on the temporary substrate;
depositing a backing material ink over the first ink and the second ink;
drying the backing material ink;
depositing a white colored ink over the backing material ink that overlies the first ink and the second ink;
drying the white colored ink over the backing material ink;
orienting the temporary substrate with respect to a permanent substrate so that at least one of the first ink, the second ink, the backing material ink, and the white colored ink interpose the temporary substrate and the permanent substrate; and
heating at least one of the temporary substrate, the image or design, the backing material ink, the white colored ink, and the permanent substrate to bond the image or design to the permanent substrate.

22. A permanent article fabricated in accordance with the method of claim 21.

23. The method of claim 21, wherein the act of heating at least one of the temporary substrate, the image or design, the backing material ink, the white colored ink, and the permanent substrate includes concurrently applying pressure to at least one of the temporary substrate, the image or design, the backing material ink, the white colored ink, and the permanent substrate.

24. The method of claim 21, wherein the act of depositing the white colored ink includes depositing the white color ink directly on the backing material ink.

25. A tangible article comprising a permanent substrate associated with an article of clothing that includes a screen printed image fabricated from a sequential deposition process that included depositing an ink followed by deposition of a backing material, followed by deposition of a white colored ink so that after the screen printed image is mounted to the permanent substrate, the white colored ink interposes the backing material and the permanent substrate.

26. The tangible article of claim 25, wherein the screen printed image is a pictorial representation fabricated by sequentially depositing a plurality of inks prior to deposition of the backing material.

27. The tangible article of claim 25, wherein the article of clothing includes at least one of a shirt, a coat, and a hat.

28. The tangible article of claim 25, wherein the screen printed image includes the white colored ink adjacent to the backing material.

29. A tangible article comprising a permanent fabric substrate associated with an article of clothing that includes a screen printed image fabricated from a sequential deposition process that included depositing an ink followed by deposition of a backing material, followed by deposition of a white colored ink so that after the screen printed image is mounted to the permanent substrate, the white colored ink interposes the backing material and the permanent substrate.

30. The tangible article of claim 29, wherein the screen printed image is a pictorial representation fabricated by sequentially depositing a plurality of inks prior to deposition of the backing material.

31. The tangible article of claim 29, wherein the article of clothing includes at least one of a shirt, a coat, and a hat.

32. The tangible article of claim 29, wherein the screen printed image includes the white colored ink adjacent to the backing material.
